(19) United States
(12) Patent Application Publication
(10) Pub. No.: US 2017/0205911 A1
(43) Pub. Date: Jul. 20, 2017

(54) TOUCH SUBSTRATE, MANUFACTURING METHOD THEREOF AND TOUCH DISPLAY PANEL

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Wenlong WANG, Beijing (CN); Hongqiang LUO, Beijing (CN)

(21) Appl. No.: 15/326,404

(22) PCT Filed: Mar. 1, 2016
(86) PCT No.: PCT/CN2016/075175

§ 371 Date: Jan. 13, 2017

(30) Foreign Application Priority Data
Apr. 9, 2015 (CN) 201510166660.1

(51) Int. Cl. G06F 3/044

(52) U.S. Cl. CPC G06F 3/044; G06F 2203/04103

(57) ABSTRACT

The embodiments of the invention provide a touch substrate, a manufacturing method thereof and a touch display panel. The touch substrate comprises a substrate, a photoresist layer and a touch electrode layer, the photoresist layer is located at the periphery of a first surface of the substrate, and the touch electrode layer is located on a second surface of the substrate. By forming the photoresist layer and the touch electrode layer on different surfaces of the substrate, the touch substrate provided in the embodiments of the invention can avoid the problem of wire breakage caused when the touch electrodes ascend in an edge region of the substrate, thereby improving the yield and the product performance of the touch substrate.

### FIELD OF THE INVENTION

The present invention relates to the field of display, and in particular to a touch substrate, a manufacturing method thereof and a touch display panel.

### BACKGROUND

According to different working principles, the existing touch substrates can be divided into several types: a capacitive type, a resistive type, an infrared type, a pressure sensing type, etc., and the capacitive touch substrate is widely used in fields such as mobile phone and tablet.

A traditional capacitive touch panel is a touch panel formed by a layer of cover glass and a layer of touch glass adhered to each other via an optically clear adhesive (OCA), i.e., it has a GG (Glass-Glass) structure. However, with the development of touch control technologies, such a structure can no longer satisfy the requirements of a touch substrate for light weight, small thickness, low cost and so on, and thus it is gradually replaced by touch control structures such as GF (Glass-Film), GFF (Glass-Film-Film) and OGS (On Glass Solution).

At present, as compared with touch control structures such as GG, GF and GFF, OGS has encountered a great challenge in terms of appearance. Conventional touch control structures like GG, GF and GFF use black ink or white ink as a light shielding material for a frame of the cover, so both a touch screen with a black frame and a touch screen with a white frame can be produced.

However, ink is less resistant to high temperature. During the high-temperature process of OGS manufacture, ink is subject to high temperature and apt to turn yellow, which affects the aesthetics. For aesthetic purposes, OGS may use white photoresist as the light shielding material of the frame, but the white photoresist on the market is far from being mature yet with a poor light shielding effect. As a result, in order to achieve the same optical effect as a cover produced with white ink, a glass cover produced with white photoresist requires white photoresist with a thickness of at least 15 μm or above. As shown in FIG. 1 and FIG. 2, a white photoresist layer 2 and a touch electrode layer 3 are arranged on a same surface of a substrate 1. Since the white photoresist layer 2 has a certain thickness, it is likely that wire breakage may occur in a position where the touch electrode layer 3 and the white photoresist layer 2 superimpose each other (i.e., in an ascending position), thereby affecting the product performance.

### SUMMARY

The technical problem to be solved by embodiments of the present invention is how to alleviate or avoid the problem of wire breakage that may occur in a position where the touch electrodes ascend in an edge region.

To solve the above technical problem, a technical solution of an embodiment of the present invention provides a touch substrate comprising a substrate, a photoresist layer and a touch electrode layer, the photoresist layer is located at a periphery of a first surface of the substrate and the touch electrode layer is located on a second surface of the substrate.

Further, the photoresist layer can comprise a white photoresist layer.

Further, the photoresist layer can further comprise a black photoresist layer located below the white photoresist layer.

Further, a first protective layer covering entirely the first surface of the substrate can be arranged above the photoresist layer.

Further, the touch electrode layer can be made of a transparent conductive material.

Further, a second protective layer covering the touch electrode layer can be further arranged on the second surface of the substrate.

Another embodiment of the present invention further provides a touch display panel, comprising the touch substrate described in any of the above embodiments.

Further, the touch display panel can comprise a display panel and the touch substrate disposed on a light exit side of the display panel.

Still another embodiment of the present invention further provides a manufacturing method of a touch substrate, which can comprise steps as follows: providing a substrate; forming a photoresist layer at a periphery of a first surface of the substrate; and forming a touch electrode layer on a second surface of the substrate.

Further, the step of forming a photoresist layer can comprise forming a black photoresist layer at a periphery of the first surface of the substrate; and forming a white photoresist layer above the black photoresist layer.

Further, the manufacturing method of a touch substrate can comprise forming a first protective layer on the first surface of the substrate; and forming a second protective layer on the second surface of the substrate.

Further, the manufacturing method of a touch substrate can further comprise steps as follows: forming a conductive film layer on the second surface of the substrate at a temperature of not lower than 300° C.; and performing a patterning process for the conductive film layer to form a pattern comprising the touch electrode layer.

Further, the conductive film layer can be formed by a sputtering or plating process.

By forming the photoresist layer and the touch electrode layer on different surfaces of the substrate, the touch substrate provided in the embodiments of the present invention can avoid the problem of wire breakage caused when the touch electrode layer ascends in an edge region of the substrate, thereby improving the yield and the product performance of a white OGS touch substrate.

### BRIEF DESCRIPTION OF DRAWINGS

FIG. 1 is a top view of a touch substrate in the prior art;

FIG. 2 is a cross-sectional view of the touch substrate in the prior art;

FIG. 3 is a cross-sectional view of a touch substrate provided in the embodiments of the present invention; and

FIG. 4 is a cross-sectional view of another touch substrate provided in the embodiments of the present invention.

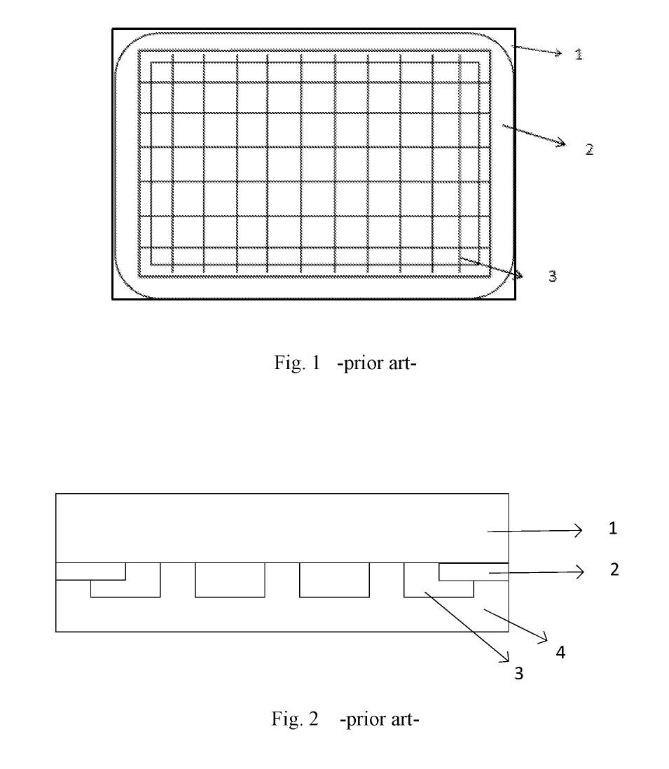

### REFERENCE SIGNS

1-substrate; 2, 21-white photoresist layer; 3-touch electrode layer; 4-second protective layer; 5-first protective layer; 6-photoresist layer; 7- black photoresist layer.

### DETAILED DESCRIPTION OF EMBODIMENTS

In order to alleviate or avoid the problem of wire breakage that may occur in a position where the touch electrodes ascend in an edge region and thus to improve the yield and the product performance of the touch substrate, the embodiments of the present invention provide a touch substrate, a manufacturing method thereof and a touch display panel. By forming a photoresist layer and a touch electrode layer on different surfaces of a substrate, the technical solutions of the embodiments of the present invention can avoid the problem of wire breakage of the touch electrodes in an ascending position. The example implementations of the present invention will be further described in detail as follows with reference to the drawings and the embodiments. The following embodiments are used for explaining the present invention, instead of limiting the scope of the present invention.

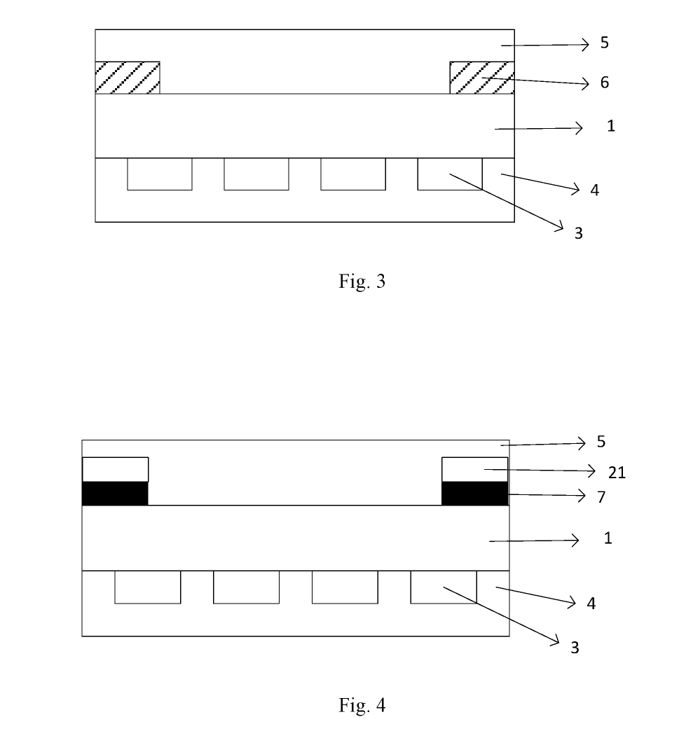

FIG. 3 is a cross-sectional view of a touch substrate provided in the embodiments of the present invention. The touch substrate comprises a substrate 1, a photoresist layer 6 and a touch electrode layer 3, the photoresist layer 6 is located at a periphery of a first surface of the substrate 1 and the touch electrode layer 3 is located on a second surface of the substrate 1.

In an embodiment, the substrate 1 can be a substrate made of different materials. For example, the substrate 1 can be made of tempered glass, and the touch electrode layer can be made of ITO (indium tin oxides) or other metallic materials.

By forming the photoresist layer 6 and the touch electrode layer 3 on different surfaces of the substrate 1, the touch substrate provided in the embodiments of the present invention can avoid the problem of wire breakage that may occur in a position where the touch electrode layer ascends in an edge region of the substrate, thereby improving the yield and the product performance of the touch substrate.

In an embodiment, the photoresist layer 6 can be a white photoresist layer. For a touch substrate, a frame made of white photoresist is more aesthetic than one made of black photoresist.

However, the white photoresist has a lower optical density value (OD value) and in turn a poor light shielding performance. Therefore, when using white photoresist as the frame material of the touch substrate, in order to achieve a better light shielding effect, it is necessary to make the white photoresist thicker, generally with a thickness of at least 15 μm or above. However, this is disadvantageous to lightness and thinness of the touch substrate.

Therefore, in order to improve the optical density value of the photoresist for a better light shielding effect, and meanwhile make the touch substrate thinner and lighter, another embodiment of the present invention provides a further touch substrate. As shown in FIG. 4, the touch substrate comprises a substrate 1 and a touch electrode layer 3. The photoresist layer can comprise a white photoresist layer 21 and a black photoresist layer 7, which are located at a periphery of a first surface of the substrate 1. The touch electrode layer 3 is located on a second surface of the substrate 1. The black photoresist layer 7 may be located between the substrate 1 and the white photoresist layer 21. By virtue of the high optical density value and the excellent light shielding performance of the black photoresist, both the black photoresist layer and the white photoresist layer can be made very thin, which not only achieves a good light shielding effect, but also lightens and thins the touch substrate. Meanwhile, placing the white photoresist layer 21 above the black photoresist layer 7 can further achieve the aesthetic purposes.

Moreover, as shown in FIG. 3 and FIG. 4, a first protective layer 5 covering entirely the first surface of the substrate 1 can be arranged above the photoresist layer, and the second surface of the substrate 1 may be provided with a second protective layer 4 covering the touch electrode layer 3, which may be respectively used for protecting the photoresist layer and the touch electrode layer against scratches.

Particularly, the first protective layer 5 covering entirely the first surface of the substrate 1 above the photoresist layer can further planarize a height difference between the photoresist layer and the substrate and achieve the effect of blanking.

In an embodiment, the first protective layer 5 and the second protective layer 4 can be made of either an organic insulating material or an inorganic insulating material.

In order to avoid influencing light exit in a display region and facilitate touch control displaying, the touch electrode layer can be made of a transparent conductive material.

Another embodiment of the present invention further provides a touch panel, comprising the touch substrate described in any of the above embodiments.

In an embodiment, the touch panel may comprise a display panel and a touch substrate disposed on a light exit side of the display panel.

In the above embodiment, by forming the photoresist layer 6 and the touch electrode layer 3 on different surfaces of the substrate 1, the problem of wire breakage caused when the touch electrode layer 3 ascends in an edge region of the substrate 1 can be alleviated or avoided, the yield and the product performance of the touch substrate can be improved in contrast to the prior art. Furthermore, using the combination of the white photoresist layer 21 and the black photoresist layer 7 as the frame material can achieve a thinner and lighter white OGS product while ensuring a good light shielding effect.

In addition, still another embodiment of the present invention further provides a manufacturing method of a touch substrate, comprising:

Step S1: providing a substrate;

Step S2: forming a photoresist layer at a periphery of a first surface of the substrate;

Step S3: forming a touch electrode layer on a second surface of the substrate.

Specifically, in step S2, the photoresist layer can be formed at the periphery of the first surface of the substrate through processes such as coating, exposure and developing. As compared with ink printing, such a production process can be more easily implemented and hence is more suitable in particular for a large production line(above six production line G6).

In an embodiment, in step S2, a black photoresist layer can be formed first at the periphery of the first surface of the substrate, and then a white photoresist layer is formed above the black photoresist layer. In this way, by virtue of the high optical density value and the excellent light shielding performance of the black photoresist, both the black photoresist layer and the white photoresist layer can be made very thin, which not only achieves a good light shielding effect, but also lightens and thins the touch substrate. Meanwhile, placing the white photoresist layer above the black photoresist layer can further achieve the aesthetic purposes.

In an embodiment, in step S3, a conductive film layer can be formed on the second surface of the substrate at a temperature of not lower than 300° C., and a patterning process is performed for the conductive film layer to form a pattern comprising the touch electrode layer. Since the white photoresist is an organic material, the manufacture of a touch electrode layer in the prior art must be carried out at a low temperature (lower than 300° C.), but the manufacture of a touch electrode layer at a low temperature is apt to reduce the adhesiveness of the touch electrode layer and the homogeneity in resistance. The technical solution provided in this embodiment can free the manufacture of a touch electrode layer from the constraint of a white photoresist material and allow the touch electrode layer to be manufactured in a high-temperature (not lower than 300° C.). condition, which effectively improves the adhesiveness of the touch electrode layer and the homogeneity in resistance.

Specifically, the conductive film layer can be formed by a sputtering or plating process.

In other embodiments, after step S3, a first protective layer can be formed on the first surface of the substrate, the first protective layer being located above the photoresist layer and covering entirely the first surface of the substrate. The first protective layer not only protects the photoresist layer against scratches, but also planarizes a height difference between the photoresist layer and the substrate. Meanwhile, the first protective layer can also achieve a blanking effect. Likewise, in order to protect the touch electrode layer against scratches, a second protective layer covering the touch electrode layer can be formed on the second surface of the substrate after the formation of a first protective layer.

It should be noted that the manufacture sequence of the photoresist layer, the touch electrode layer, the first protective layer and the second protective layer is selectable upon differences in the processes. It is only necessary that the first protective layer be manufactured after the manufacture of the photoresist layer and that the second protective layer be manufactured after the manufacture of the touch electrode layer.

The above embodiments are only used for explaining the present invention, rather than limiting the invention. Those having ordinary skills in the art can further make various modifications and variations without deviating from the spirits and scopes of the present invention. Thus all equivalent technical solutions shall fall within the scope of the present invention and the patent protection scope of the present invention should be subject to the claims.

1. A touch substrate comprising a substrate, a photoresist layer and a touch electrode layer, wherein the photoresist layer is located at a periphery of a first surface of the substrate and the touch electrode layer is located on a second surface of the substrate.

2. The touch substrate according to claim 1, wherein the photoresist layer comprises a white photoresist layer.

3. The touch substrate according to claim 2, wherein the photoresist layer further comprises a black photoresist layer located below the white photoresist layer.

4. The touch substrate according to claim 1, wherein a first protective layer covering entirely the first surface of the substrate is further arranged above the photoresist layer.

5. The touch substrate according to claim 1, wherein the touch electrode layer is made of a transparent conductive material.

6. The touch substrate according to claim 5, wherein a second protective layer covering the touch electrode layer is further arranged on the second surface of the substrate.

7. A touch display panel comprising a touch substrate, the touch substrate comprising a substrate, a photoresist layer and a touch electrode layer, wherein the photoresist layer is located at a periphery of a first surface of the substrate and the touch electrode layer is located on a second surface of the substrate.

8. The touch display panel according to claim 7, wherein the touch display panel comprises a display panel and the touch substrate disposed on a light exit side of the display panel.

9. A manufacturing method of a touch substrate, comprising:
providing a substrate;
forming a photoresist layer at a periphery of a first surface of the substrate; and
forming a touch electrode layer on a second surface of the substrate.

10. The manufacturing method of a touch substrate according to claim 9, wherein the step of forming a photoresist layer comprises:
forming a black photoresist layer at the periphery of the first surface of the substrate; and
forming a white photoresist layer above the black photoresist layer.

11. The manufacturing method of a touch substrate according to claim 9, wherein the method further comprises steps of:
forming a first protective layer on the first surface of the substrate; and
forming a second protective layer on the second surface of the substrate.

12. The manufacturing method of a touch substrate according to claim 9, wherein the method further comprises steps of:
forming a conductive film layer on the second surface of the substrate at a temperature of not lower than 300° C.; and
performing a patterning process for the conductive film layer to form a pattern comprising the touch electrode layer.

13. The manufacturing method of a touch substrate according to claim 12, wherein the conductive film layer is formed by a sputtering or plating process.

14. The touch substrate according to claim 2, wherein a first protective layer covering entirely the first surface of the substrate is further arranged above the photoresist layer.

15. The touch substrate according to claim 3, wherein a first protective layer covering entirely the first surface of the substrate is further arranged above the photoresist layer.

16. The touch display panel according to claim 7, wherein the photoresist layer comprises a white photoresist layer.

17. The touch display panel according to claim 16, wherein the photoresist layer further comprises a black photoresist layer located below the white photoresist layer.

18. The touch display panel according to claim 7, wherein a first protective layer covering entirely the first surface of the substrate is further arranged above the photoresist layer.

19. The touch display panel according to claim 7, wherein the touch electrode layer is made of a transparent conductive material.

20. The touch display panel according to claim 19, wherein a second protective layer covering the touch electrode layer is further arranged on the second surface of the substrate.
